(19) United States
(12) Patent Application Publication
(10) Pub. No.: US 2022/0014467 A1
(43) Pub. Date: Jan. 13, 2022

(54) INFORMATION CENTRIC NETWORK ROUTING

(71) Applicants: Sunil Cheruvu, Tempe, AZ (US); Ned M. Smith, Beaverton, OR (US); Francesc Guim Bernat, Barcelona (ES)

(72) Inventors: Sunil Cheruvu, Tempe, AZ (US); Ned M. Smith, Beaverton, OR (US); Francesc Guim Bernat, Barcelona (ES)

(21) Appl. No.: 17/483,510

(22) Filed: Sep. 23, 2021

(51) Int. Cl. H04L 12/743; H04L 12/717; H04L 12/733

(52) U.S. Cl. CPC H04L 45/7453; H04L 45/20; H04L 45/42

(57) ABSTRACT

System and techniques for information centric network (ICN) routing are described herein. An ICN node receives an interest packet including a name for content. The name is hashed to create an index. A bit that corresponds to the index is retrieved from an array of bits. The ICN node then routes the interest packet based on the bit.

### TECHNICAL FIELD

Embodiments described herein generally relate to computer networking and more specifically to information centric network (ICN) routing.

### BACKGROUND

Information centric networks (ICNs) implement protocols and mechanisms where communications between machines for information or computational services are specified by name. This is in contrast to traditional (legacy) networks and protocols in which communications include addresses (e.g., and ports) of specific end-points (e.g., a host Internet Protocol (IP) address). In ICN operations, an interest packet (e.g., request) arrives at an ICN node. The interest packet includes a name for the requested content. If the content happens to be in content store (CS) (e.g., local cache) of the ICN node, the interest is satisfied with the data from the CS. To satisfy the interest, the ICN node transmits a data packet including the content out of the interface (e.g., face) from which the interest was received. If the content is not in the CS, the incoming interest is recorded in a pending interest table (PIT) along with information about the requestor (e.g., incoming face). The interest, if not already in the PIT (e.g., due to some other requestor), represents a new need to seek the requested data from some other node. Accordingly, the ICN node consults a Forwarding information base (FIB) to route the interest forward neighbor ICN nodes. In this way, interests navigate to the nearest node that has the requested data in its content store, or to an original publisher. When the data packet in response to the interest traverses back to the original requester, the intervening PIT entries are used to find the route, akin to following a trail of breadcrumbs, and the data may be cached at each node the data packet traverses. A named function network (NFN) is an ICN where names refer to functions to be executed. Thus, the interest packet may include a name of a function and possibly parameters to execute the function and the data packet includes the results of the function.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A, 1B, and 1C illustrate an example of an environment including a system for ICN routing, according to an embodiment.

FIG. 2 illustrates an example of multiple bloom filters for hardware tenants, according to an embodiment.

FIG. 3 illustrates an overview of an edge cloud configuration for edge computing.

FIG. 4 illustrates operational layers among endpoints, an edge cloud, and cloud computing environments.

FIG. 5 illustrates an example approach for networking and services in an edge computing system.

FIG. 6 illustrates deployment of a virtual edge configuration in an edge computing system operated among multiple edge nodes and multiple tenants.

FIG. 7 illustrates various compute arrangements deploying containers in an edge computing system.

FIG. 8A provides an overview of example components for compute deployed at a compute node in an edge computing system.

FIG. 8B provides a further overview of example components within a computing device in an edge computing system.

FIG. 9 illustrates an example software distribution platform to distribute software.

FIG. 10 illustrates an example information centric network (ICN), according to an embodiment.

FIG. 11 illustrates a flow diagram of an example of a method for ICN routing, according to an embodiment.

FIG. 12 is a block diagram illustrating an example of a machine upon which one or more embodiments may be implemented.

### DETAILED DESCRIPTION

ICN devices perform several lookups during standard routing procedures. Such lookups include determining whether named content is in a local content store, forward information base (FIB) lookups to determine which interface to forward an interest packet, or pending interest table (PIT) lookups to determine which interface to transmit a data packet. Number and complexity of these lookups may impact the performance of ICN routers.

To address this issue, a filter mechanism, such as a Bloom filter, may be employed. In general, a Bloom filter applies one or more (e.g., three to seven) hashes to content, such as the content name found interest or data packets. Each hash produces one index in a bit array. Thus, if three hashes are used, three bits are set in the bit array, one for each hash. When an ICN node receives content, the name may be hashed and the bits in the bit array set. Then, when a new packet arrives, the name is hash in a similar manner to find the bit array indices. If the bits are set, the content may be there (e.g., in a content store or PIT entry). Bloom filters do not guarantee the content is there because collision may occur. However, the filter provides a definitive answer if the content is not there because one or more of the bits will be unset. Using this technique, the ICN router may avoid processing all packets for which the ICN route cannot provide the data or a route (e.g., via a PIT entry or a FIB entry).

The filters may be shared with neighboring nodes. Thus, a first node may update a local FIB entry for a second node with the second node's filter. In this manner, forward routes may be efficiently identified. Further, a multi-dimensional filter may be employed, in which the first dimension operates as the filter element and the additional dimensions add more sophisticated information. For example, an additional dimension may include a list of names (e.g., function names in an NFN) to which the filter matches. In an example, an additional dimension may include hop counts for the names in the list of names. This additional information may be retrieved as a by-product of the filter test requiring no additional lookup. Thus, forward routes may be quickly identified and even sorted for efficiency based on whichever has the lowest hop count.

Further, when the filters operate similarly to a Bloom filter, combining filters is an efficient bitwise OR of two filters. Thus, an ICN node may combine a filter for its own content store with that of a neighbor ICN node to determine whether or not the ICN node is able to handle an interest packet, for example, either locally or with a forward route, using a single filter operation. Again, the decision of whether or not the ICN node will handle the packet may be made quickly with limited processing resources, improving overall routing performance. Additionally, using hop counts in shared filters, the ICN node may forward packets to reduce total hop counts and again improve network routing performance for interest or data packets.

The filter sharing may also extend to terminal (e.g., non-routing) nodes, such as end user nodes. For example, if an NFN Router constructs a two-dimensional (2D) Bloom filter (BF) table—e.g., a multi-dimensional filter—with function names and hop indices, and cascades the table to other nodes in the network, the table may be shared and combined with each NFN router and edge device. An end user device may use the table to select an outbound interface (or even a specific node) at a hop index for desired content to reduce latency and network packet transmission in retrieving the content.

The systems, devices, and techniques described herein improve the routing efficiency on named domains (e.g., ICN routing). Filter effectiveness may be impaired if the ICN nodes sharing filters because too high (e.g., in the millions). Here, zones of nodes propagating filters may be employed. In an example, a hierarchical filter between zones may be used to cross zone boundaries. Additional details and examples are provided below.

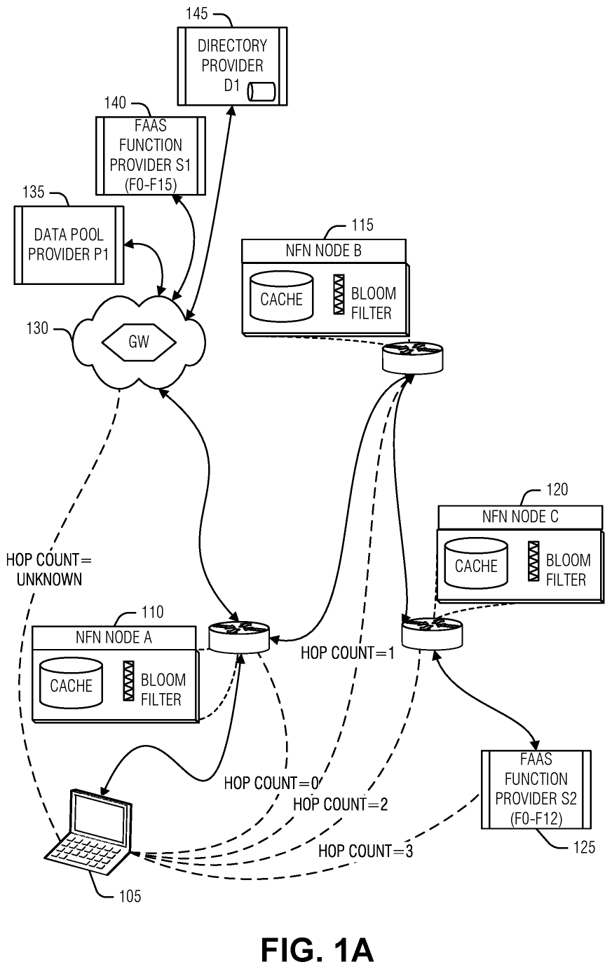

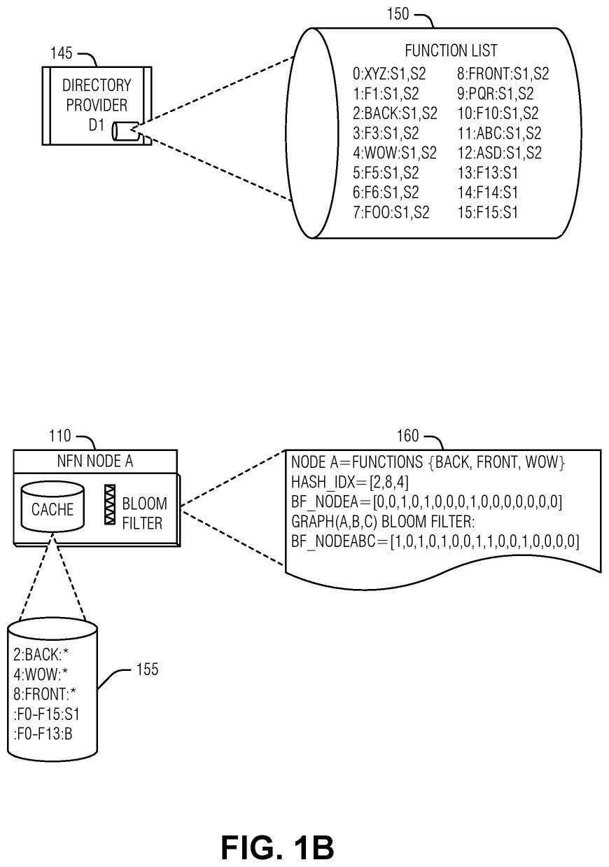

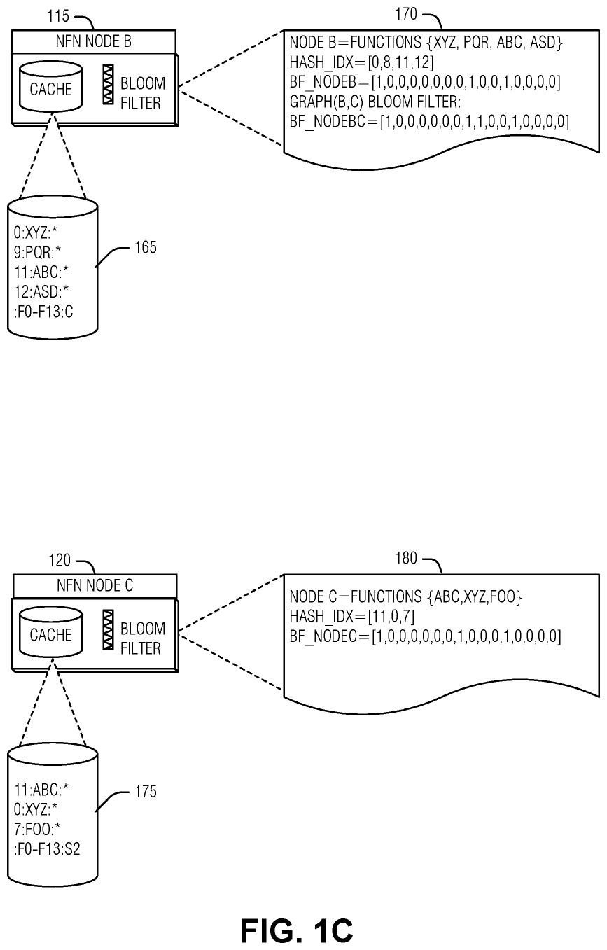

FIGS. 1A, 1B, and 1C illustrate an example of an environment including a system for ICN routing, according to an embodiment. FIG. 1A illustrates an arrangement of nodes in an NFN and FIGS. 1B and 1C illustrate example details of bloom filters on NFN node A 110 (e.g., filter data 160), NFN node B 115 (e.g., filter data 170) and NFN node C 120 (e.g., filter data 180) as well as an optional directory 150 on a directory provider D1 145. Although the illustrated example is for an NFN, the principles apply equally to other ICNs.

As illustrated, a terminal device 105 is connected to NFN node A 110. NFN node A 110 is connected to a gateway 130 and NFN node B 115. NFN node B 115 is connected to NFN node C 120. NFN node C 120 is connected to a function as a service (FaaS) provider S2 125.

The gateway 130 provides connections (e.g., through a cloud) to FaaS provider S1 140, the directory provider D1 145, and a data pool provider P1 135. The directory provider D1 145 includes the directory 150, which correlates function names to hash indices that result from applying the BF to the functions (e.g., function names are the entire function) and providers of the function. Thus, the directory 150 may simplify routing decisions at, for example, the terminal device 105.

The NFN nodes—NFN node A 110, NFN node B 115, and NFN node C 120—each include a content store (e.g., local cache 155, local cache 165, and local cache 175 respectively) and a filter data—the filter data 160, the filter data 170, and the filter data 180 respectively. Each NFN node also includes processing circuitry that is arranged (e.g., prearranged or hardware, or configured by software, such as firmware or microcode) to use the BF to facilitate routing. The following examples are presented from the perspective of NFN node A 110 for simplicity but equally apply to any ICN routing.

The processing circuitry of NFN node A 110 is arranged to receive an interest packet (e.g., from the terminal device 105) that includes a name for content. In an example, the content is data. In an example, the content is a result of a function. In an example, the ICN node executes the function to produce the result in response to the interest packet. The difference between these examples is simply whether the name specifies the data itself, or whether the name specifies a function, the result of which is what is being requested. Thus, in an NFN, the name, such as WOW or FOO as illustrated, along with possible parameters for the function are included in the interest packet. A provider executes the function to produce a result and returns the result in a data packet. In contrast, when the content is data, the name is unique to the data and the data may simply be returned when found (e.g., by a provider).

The processing circuitry is arranged to hash the name of the interest packet is hashed to create an index. Although the name is hashed in this example, any content of the interest packet that is unique may be cached to produce the index. Thus, for example, the entire interest packet may be hashed, or any sub-portion of the interest packet may be hashed along with the name. As long as the hash applies to an element of the interest packet that differentiates the interest packet from interest packets for distinct requests, the index produced by the hash will work.

The processing circuitry is arranged to receive a bit that corresponds to the index from an array of bits. The combination of the hash index (e.g., the index produced from the hashing of the content name) and looking at the bit array at the index combine to be the filter. In an example, the bit indicates that the content may be present on the ICN node. Here, like a BF, the content is filtered out indicating that the content is not on NFN node A 110 is the bit at the index is unset. Generally, the bits of the bit array may be initialized to zero, indicating that they are unset. When the bit is set, it is changed to a one. Thus, if any index produced by the hashing yields a bit that is zero, then the content is matched by the filter and, for example, the content is not in the content store 155 of NFN node A 110. However, if the bit is set, then the content is matched. However, to control filter sizes, the bit array may produce more hash collisions than, for example, a hash-keyed table. Collisions will match distinct content in this case. Accordingly, the NFN node A 110 will perform additional processing to determine whether or not the named content is in whatever structure—such as the cache 155, a PIT, or a FIB—before responding or forwarding the packet.

In an example, the hash and the bit array are a bloom filter. In an example, the bloom filter is a cryptographic bloom filter. Cryptographic bloom filters generally involve using a cryptographic hash, such as SHA256. Whereas traditional Bloom filters may not care if a hash is fakeable, a cryptographic hash is resistant to faking. Thus, for example, if the entirety of the function is hashed using the cryptographic hash, a modified version of the function will not match a cryptographic Bloom filter. This may prevent malicious versions of the function from being used. In an example, the processing circuitry is arranged to expunge a version of the content in response to the bit indicating that the content is not on the ICN node. Here, the version of the content may be matched to the packet based on the name. However, a result of the hash indicates that the content itself is different. Thus, a local copy (which may have been compromised) is removed.

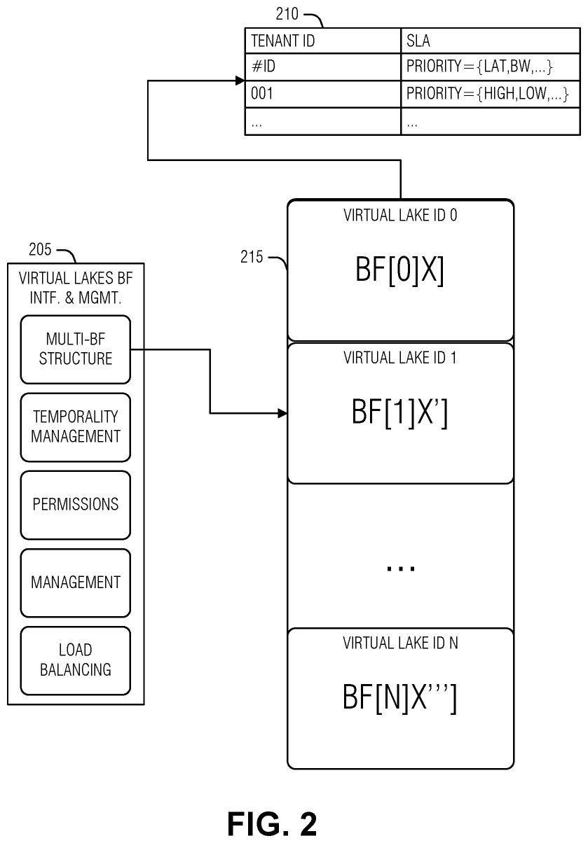

In an example, the bit array is one of multiple bit arrays used by the ICN node for interest packet routing. Here, the multiple bit arrays are respectively assigned to tenants of the ICN node. Additional details are illustrated in FIG. 2 and discussed below, but this example notes that NFN node A 110 may include different partitions, applications, or other entities that are kept separate by hardware. Here, these entities are referred to as tenants and there may be a filter for each tenant, or a subset of tenants may share a filter. In either case, the NFN node A 110 includes multiple filters for its tenants. In an example, the multiple bit arrays each have a set of properties. In an example, the properties include load balancing, permission, or temporality that are assigned to a tenant from the tenants.

The processing circuitry is arranged to route the interest packet based on the bit. As noted above, the bit may indicate that the content may be present on the ICN node. Here, routing the interest packet based on the bit includes finding the content in the cache 155 and transmitting a data packet with the content in accordance with an entry for the interest packet in NFN node A's PIT. Where the content is a function, the processing circuitry is arranged to execute the function and provide the result in the data packet. In any case, NFN node A 110 routes the interest packet by handling the request represented by the interest packet.

Because there is a possibility that the data is not in NFN node A 110 even if the interest packet matches the filter, in an example, routing the interest packet based on the bit includes searching for the content in the cache 155 to determine that the content is not available at the ICN node. Here, the processing circuitry may be arranged to a second bit from a second array of bits corresponding to forward routes. This is a second filter for forward routes. An example of this second filter is illustrated as BF_NODEABC in the filter data 160. The processing circuitry is arranged to route (e.g., forward) the interest packet based on the second bit. In an example, the second bit indicates that the content is not present on a forward route. Here, routing the interest packet based on the second bit includes dropping the interest packet.

In an example, the second bit indicates that the content may be present on one or more forward routes. Here, routing the interest packet may include the processing circuitry arranged to transmit the interest packet along the one or more forward routes. In an example, a data structure is searched using the index to determine the one or more forward routes based on the index and the name. This is the multidimensional filter introduced above. In an example, the data structure includes a set of properties for the content. In an example, properties include one or more of a content name, hop count, or hash index. The table below is an example of a two-dimensional filter that includes these properties.

In an example, the searching the data structure produces multiple forward routes as results. This indicates that several providers may be used to satisfy the interest packet. For example, as illustrated, both FaaS function provider S1 140 and FaaS function provider S2 125 include the WOW function as indicated in the directory 150. In these cases, routing the interest packet may include ordering the multiple forward routes based on hop count and selecting the highest ordered route. Then, the interest packet is transmitted using the highest ordered route. In this example, whichever route has the lowest hop count, which will be ordered (e.g., sorted) higher, will be chosen and to that interface the interest packet will be sent. This is an efficient and effective technique to reduce hop counts, and thus reduce latency or overall network traffic.

In an example, a third bit array from is received from an ICN node on a forward route. Thus, the third bit array may be the filter from NFN node B 115 that was transmitted to NFN node A 110. The processing circuitry is arranged to bitwise-ORed the third bit array with the second bit array to produce a result. This is the combined BF_NODEABC filter illustrated in filter data 160. Note that, for each bit set in the BF_NODEA filter in the filter data 160, the BF_NODEB filter in the filter data 170, and the BF_NODEC filter in filter data 170, a bit at the same index is set in BF_NODEABC. This illustrates the result of bitwise-ORing these filters together. In an example, the second bit array (e.g., the filter BF_NODEABC in the filter data 160) may be set to (e.g., replaced by) this result. Thus, the forward routes are updated with any changes from these forward nodes (e.g., NFN node B 115 or NFN node C 120 with respect to NFN node A 110. In an example, the third bit array may be received in a data packet from the node on the forward route. Because the filter bit arrays tend to be small, passing the arrays as extra data in data packets or interest packets may be an efficient technique to avoid extra network overhead in maintain synchronization of the filters across nodes.

The following provides another prospective on the features described above. For example, periodically the routers may communicate their BFs via cascading. When a user 105 submits an interest packet, the first node's final BF is inspected for the presence of the function in the cache 155 and, if found, the hop index is retrieved and the user 105 may directly request the function to be perform from the node at hop index. In an example, the directory provider 145 may supply a directory 150 with a function list that identifies all functions available—such as by FaaS function provider S1 140 and FaaS function provider S2 125—in the network or network of networks isolated by the gateway 130. The user 105 may query the directory provider 145 as part of a discovery process that identifies which NFN functions are available for use.

Routing nodes—such as NFN node A, NFN node B 115, or NFN node C 120—may cache NFN functions and may use a BF to efficiently route requests to either NFN routing node caches or to function providers. The NFN Nodes' cache content may contain NFN code—such as programs, object code, executable code, binaries, scripts, binary translations, executable metadata, etc.—an NFN Code Name, or a cache index value (as illustrated in the function list of the directory 150). The illustrated example is a sparse index of sixteen bits where a hash of the function name results in a collision (e.g., the bit at the index found by the hash is a one) in the sparse index. Here, a Bloom hash function maps the NFN function into the sparse index according to one of its bit positions (e.g., 0-15). The index may also map to function names that may be used to locate entries in a routing node cache (e.g., the cache 155). A multidimensional Bloom filter may contain hop counts for improved routing efficiency. In an example, if there are multiple routes, multiple hop counts may exist. The router may use the hop count information to locate the cache entry that returns the nearest route (e.g., the shortest path or fewest number of hops). In an example, the cache 155 may also contain routing information to a nearest routing node or endpoint node (e.g., terminal node) that contains the specified (e.g., in an interest packet) NFN code.

The table below is based on a BF of size 16 bits. In the table, the function PQR on NFN Node B 115 has a hash index of 8 with a hop index of 1, but function FRONT on NFN Node A 110 also has hash of eight with a hop count of zero resulting in a collision. This collision may be resolved by looking up the function names linearly, for example, first at hop index zero and then at hop index one. If there is a collision where a single hash index has multiple hop indices, they may be attempted one by one. As illustrated, a * in a cached, such as the cache 165, means that the function is serviceable from the node (e.g., NFN node B 115) and has a hop count of 0.

| Sparse Index | | | |
|---|---|---|---|
| (e.g., from the | | Hash | Hop |
| directory 150) | Function | Index | Count |
| 0 | XYZ | 0 | 1, 2 |
| 1 | F1 | 8 | 3 |
| 2 | BACK | 2 | 0 |
| 3 | F3 | 14 | 3 |
| 4 | WOW | 4 | 0 |
| 5 | F5 | 4 | 3 |
| 6 | F6 | 13 | 3 |
| 7 | FOO | 7 | 2 |
| 8 | FRONT | 8 | 0, 1 |
| 9 | PQR | 8 | 1 |
| 10 | F10 | 8 | 3 |
| 11 | ABC | 11 | 1, 2 |
| 12 | ABC | 11 | 1 |
| 13 | F13 | 1 | 3 |
| 14 | F14 | 4 | Unknown |
| 15 | F15 | 7 | Unknown |

The hop counts enable more informed routing decisions. For example, when evaluating a BF match that has multiple possible routes—such as the hash index eight—the hop count identifies two possible options for satisfying the interest packet, one from local cache the other from the next hop NFN node C 120. In an example, function names present in caches are mapped to BFs and vice versa.

In an example, where nodes maintain a cache with the functions it has seen before, BFs (e.g., having a sixteen bit filter array size) and a hash function e.g., Bloom Filter Hash function (BFn)={fnv1a_32})—or multiple hash algorithmic functions may be leveraged to reduce the collisions—may be used to improve routing.

The BFn may compute a hash of the NFN function name (e.g., XYZ) or may compute a hash of the NFN Code (e.g., BFn=Reduce (SHA2 (code))) such that the 256-bit SHA2 hash result is further reduced to the BF size (e.g., sixteen bits). A reduce function may result in more BF index collisions but will generally not lose information about a possible route.

The illustrated caching of NFN Code in different nodes and the combined BF is shown below:
Node C=Functions {ABC, XYZ, FOO}
Hash Index=[11, 0, 7]
BF_NodeC=[1, 0, 0, 0, 0, 0, 0, 1, 0, 0, 0, 1, 0, 0, 0, 0]
Node B=Functions {XYZ, PQR, ASD}
Hash Index=[0, 8, 11]
BF_NodeB=[1, 0, 0, 0, 0, 0, 0, 0, 1, 0, 0, 1, 0, 0, 0, 0]
After adding Nodes B to C
BF_NodeBC=[1, 0, 0, 0, 0, 0, 0, 1, 1, 0, 0, 1, 0, 0, 0, 0]
Node A=Functions{BACK, FRONT, WOW}
Hash Index=[2, 8, 4]
BF_NodeA=[0, 0, 1, 0, 1, 0, 0, 0, 1, 0, 0, 0, 0, 0, 0, 0]
Final combined Bloom Filter:
Final_BF=[1, 0, 1, 0, 1, 0, 0, 1, 1, 0, 0, 1, 0, 0, 0, 0]

NFN node B 115 may check if another FaaS flavor node has the function by retrieving the cache-bloom filters and ORing them to determine if the function is cached. Testing the membership is as simple as applying the hash function to get the index and checking whether the bit is set at the index in the final BF. Thus, for the WOW function:
Hash Index=4
wow_res1=[0, 0, 0, 0, 1, 0, 0, 0, 0, 0, 0, 0, 0, 0, 0, 0]
Final_BF=[1, 0, 1, 0, 1, 0, 0, 1, 1, 0, 0, 1, 0, 0, 0, 0]
   The bit at hash index location 4 is ‘1’ in Final BF so the function WOW may be present in cache.

Without these techniques, user processes or routing nodes may require excess memory to store routing information in a PIT. Interest packets may be routed over inefficient routes resulting in cached routes that are less efficient. Using these techniques, filtering (e.g., using a BF) is a compact bandwidth efficient mechanism for communicating changes in network topology. For example, after an interest packet is returned (e.g., by a data packet establishing the router to NFN code contents). function providers or routing nodes may periodically refresh established routes using BF updates. Additionally, routing nodes may further optimize a route based on hop counts where the user's nearest routing node has a hop count of zero.

In an example, the filter may be used to increase network security. For example, the filter hash function may use longer bit array sizes—such as 256 512 bit arrays—to match the array size of a cryptographic hash algorithm (e.g., SHA2). Such filters may be referred to as cryptographic filters, such as Cryptographic Bloom Filter (CBF) when the filter is a BF. This approach enables the filter to track the integrity of the functions (e.g., NFN Code) across the network. If an instance of NFN Code changes in one of the caches or on a function provider, the CBF values will differ resulting in a broken route. This has a desirable security property because routing to compromised NFN Code results in delivery of malware users.

In an example, caches may be marked invalid as a result of a broken route. In an example, routing nodes may respond to invalid cache entries by requesting an attestation of the content. Attestation requests may ignore cached contents resulting in a mandatory routing to the provider (e.g., FaaS function provider S1 140. In an example, attestation produces a new content hash value that may include a correctness-confidence-value or weight as determined by the attestation policy evaluating the provider's security posture. The routing node may subsequently update its cache and filter with the new value that is known to be good.

FIG. 2 illustrates an example of multiple bloom filters for hardware tenants, according to an embodiment. The filter technique to improves routing described herein may be expanded in order to incorporate a list of potential virtual data lakes IDs—which may be mapped to one or multiple tenants—to group content in domains. These virtual data lakes enable implementation of policies per tenant or groups of tenants—what data in the filter is exposed to whom, implementation of specific load balancing policies within a domain—such as particular quality of service (QoS) policies or load balancing across users of a particular domain, and provision of a more scalable solution for large scale deployments. To accomplish this, the filter may be expanded in a hierarchy of filters. For example, different BFs may be defined, each of them mapped to one or multiple tenants.

As illustrated, the management hardware 205 supports virtual lake implementation. This includes a set of virtual lake BFs 215. In an example, each virtual lake BF may include attached properties 210, which may be different across virtual lake BFs in the set of virtual lake BFs 215. The properties may include a variety of metadata that applies to a virtual lake BF. Three categories of these properties may include load balancing, permissions, or temporality. For example, with load balancing, each tenant mapped to the virtual lake BF may have certain service level agreement (SLA) levels. Here, if content is cached in multiple levels, depending on the SLA, the properties 210 in the virtual lake BF may redirect to a node at one hop count over another node at another hop count. Similarly, the load balancing property may provide different load balancing policies (e.g., round robin, batching etc.) based on the behavior (e.g., performance measurements) of the virtual lake.

With respect to permissions, the properties may provide different visibility on different parts of the virtual lake BF for different tenants within the same virtual lake BF, such that some content is only visible to some tenants). For example, a particular virtual lake BF may not be visible to tenants that are not being actively mapped as part of that virtual lake BF.

With respect to temporality, the properties 210 may provide shorter or longer durations (e.g., of staleness) depending on the nature of the data. For example, virtual lake BF entries associated to tenant A in BF[0][X] may expire after one day of being included in the virtual lake BF, while entries associated to any tenant in BF[1][X] may have temporality of one minute.

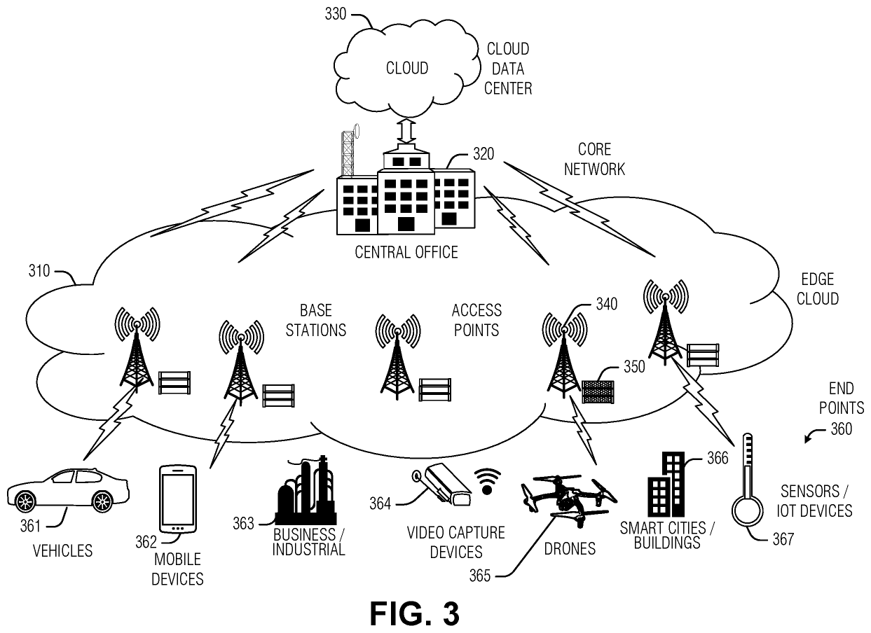

FIG. 3 is a block diagram showing an overview of a configuration for edge computing, which includes a layer of processing referred to in many of the following examples as an “edge cloud”. As shown, the edge cloud 310 is co-located at an edge location, such as an access point or base station 340, a local processing hub 350, or a central office 320, and thus may include multiple entities, devices, and equipment instances. The edge cloud 310 is located much closer to the endpoint (consumer and producer) data sources 360 (e.g., autonomous vehicles 361, user equipment 362, business and industrial equipment 363, video capture devices 364, drones 365, smart cities and building devices 366, sensors and IoT devices 367, etc.) than the cloud data center 330. Compute, memory, and storage resources which are offered at the edges in the edge cloud 310 are critical to providing ultra-low latency response times for services and functions used by the endpoint data sources 360 as well as reduce network backhaul traffic from the edge cloud 310 toward cloud data center 330 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the number of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

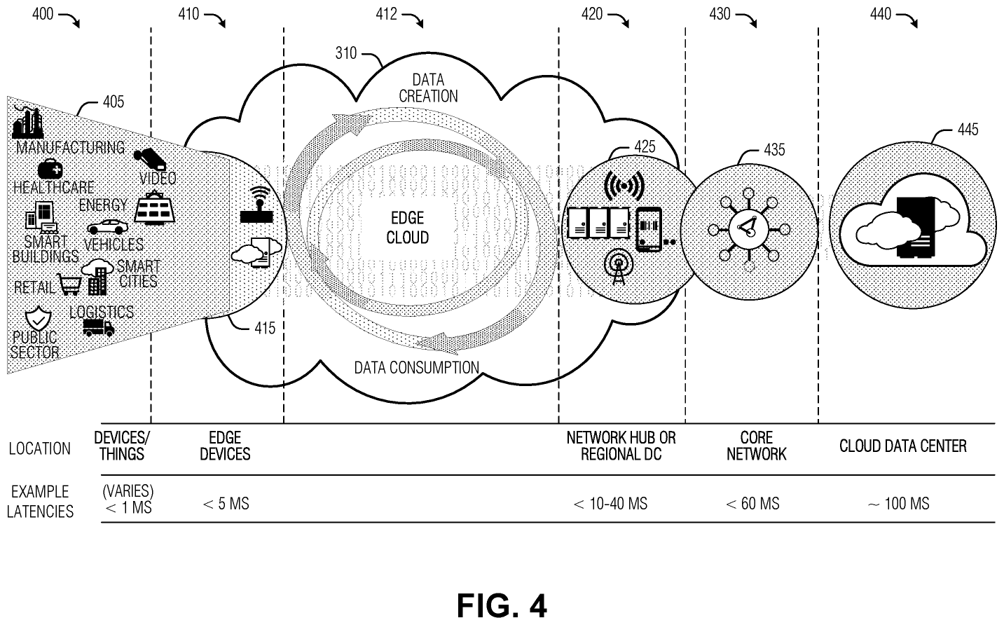

FIG. 4 illustrates operational layers among endpoints, an edge cloud, and cloud computing environments. Specifically, FIG. 4 depicts examples of computational use cases 405, utilizing the edge cloud 310 among multiple illustrative layers of network computing. The layers begin at an endpoint (devices and things) layer 400, which accesses the edge cloud 310 to conduct data creation, analysis, and data consumption activities. The edge cloud 310 may span multiple network layers, such as an edge devices layer 410 having gateways, on-premise servers, or network equipment (nodes 415) located in physically proximate edge systems; a network access layer 420, encompassing base stations, radio processing units, network hubs, regional data centers (DC), or local network equipment (equipment 425); and any equipment, devices, or nodes located therebetween (in layer 412, not illustrated in detail). The network communications within the edge cloud 310 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 400, under 5 ms at the edge devices layer 410, to even between 10 to 40 ms when communicating with nodes at the network access layer 420. Beyond the edge cloud 310 are core network 430 and cloud data center 440 layers, each with increasing latency (e.g., between 50-60 ms at the core network layer 430, to 100 or more ms at the cloud data center layer). As a result, operations at a core network data center 435 or a cloud data center 445, with latencies of at least 50 to 100 ms or more, will not be able to accomplish many time-critical functions of the use cases 405. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 435 or a cloud data center 445, a central office or content data network may be considered as being located within a “near edge” layer (“near” to the cloud, having high latency values when communicating with the devices and endpoints of the use cases 405), whereas an access point, base station, on-premise server, or network gateway may be considered as located within a “far edge” layer (“far” from the cloud, having low latency values when communicating with the devices and endpoints of the use cases 405). It will be understood that other categorizations of a particular network layer as constituting a “close”, “local”, “near”, “middle”, or “far” edge may be based on latency, distance, number of network hops, or other measurable characteristics, as measured from a source in any of the network layers 400-440.

The various use cases 405 may access resources under usage pressure from incoming streams, due to multiple services utilizing the edge cloud. To achieve results with low latency, the services executed within the edge cloud 310 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 310 may provide the ability to serve and respond to multiple applications of the use cases 405 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 310 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 310 (network layers 400-440), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 310.

As such, the edge cloud 310 is formed from network components and functional features operated by and within edge gateway nodes, edge aggregation nodes, or other edge compute nodes among network layers 410-430. The edge cloud 310 thus may be embodied as any type of network that provides edge computing or storage resources which are proximately located to radio access network (RAN) capable endpoint devices (e.g., mobile computing devices, IoT devices, smart devices, etc.), which are discussed herein. In other words, the edge cloud 310 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage or compute capabilities. Other types and forms of network access (e.g., Wi-Fi, long-range wireless, wired networks including optical networks) may also be utilized in place of or in combination with such 3GPP carrier networks.

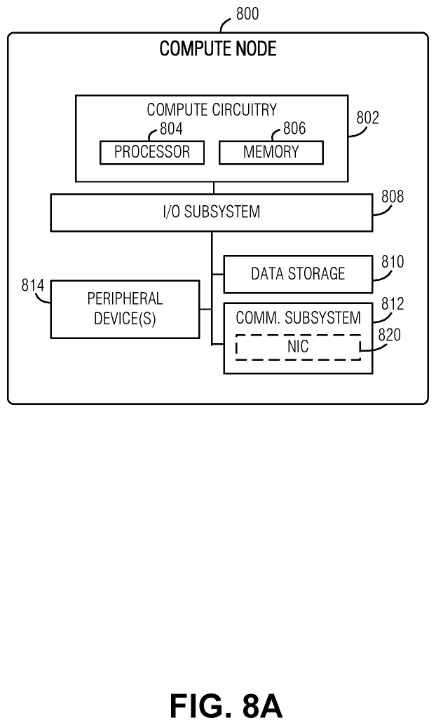

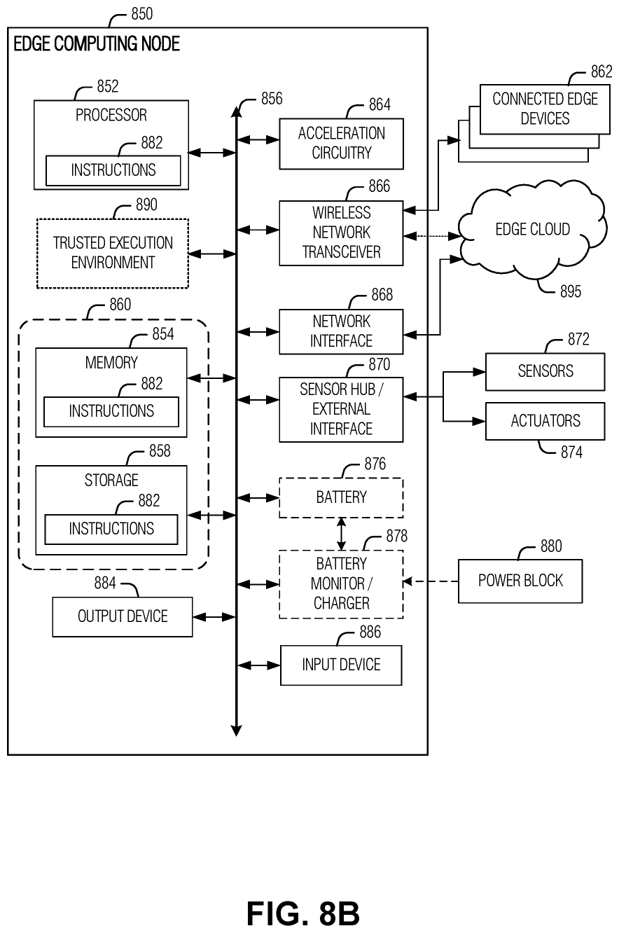

The network components of the edge cloud 310 may be servers, multi-tenant servers, appliance computing devices, or any other type of computing devices. For example, the edge cloud 310 may include an appliance computing device that is a self-contained electronic device including a housing, a chassis, a case or a shell. In some circumstances, the housing may be dimensioned for portability such that it can be carried by a human or shipped. Example housings may include materials that form one or more exterior surfaces that partially or fully protect contents of the appliance, in which protection may include weather protection, hazardous environment protection (e.g., EMI, vibration, extreme temperatures), or enable submergibility. Example housings may include power circuitry to provide power for stationary or portable implementations, such as AC power inputs, DC power inputs, AC/DC or DC/AC converter(s), power regulators, transformers, charging circuitry, batteries, wired inputs or wireless power inputs. Example housings or surfaces thereof may include or connect to mounting hardware to enable attachment to structures such as buildings, telecommunication structures (e.g., poles, antenna structures, etc.) or racks (e.g., server racks, blade mounts, etc.). Example housings or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface or mounted to the surface of the appliance. Example housings or surfaces thereof may support mechanical connectivity, such as propulsion hardware (e.g., wheels, propellers, etc.) or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 8B. The edge cloud 310 may also include one or more servers or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications or other software, code or scripts may execute while being isolated from one or more other applications, software, code or scripts.

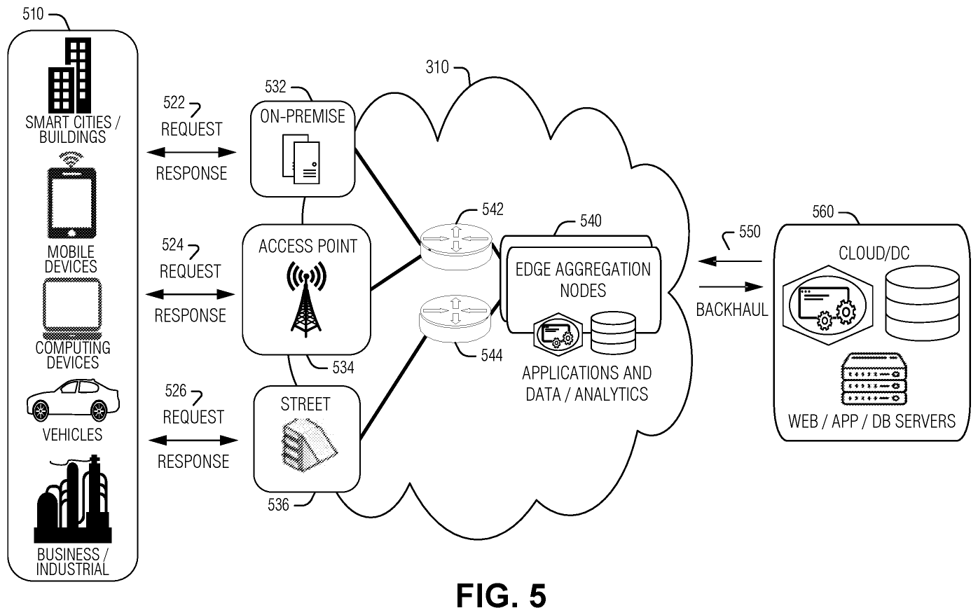

In FIG. 5, various client endpoints 510 (in the form of mobile devices, computers, autonomous vehicles, business computing equipment, industrial processing equipment) exchange requests and responses that are specific to the type of endpoint network aggregation. For instance, client endpoints 510 may obtain network access via a wired broadband network, by exchanging requests and responses 522 through an on-premise network system 532. Some client endpoints 510, such as mobile computing devices, may obtain network access via a wireless broadband network, by exchanging requests and responses 524 through an access point (e.g., cellular network tower) 534. Some client endpoints 510, such as autonomous vehicles may obtain network access for requests and responses 526 via a wireless vehicular network through a street-located network system 536. However, regardless of the type of network access, the TSP may deploy aggregation points 542, 544 within the edge cloud 310 to aggregate traffic and requests. Thus, within the edge cloud 310, the TSP may deploy various compute and storage resources, such as at edge aggregation nodes 540, to provide requested content. The edge aggregation nodes 540 and other systems of the edge cloud 310 are connected to a cloud or data center 560, which uses a backhaul network 550 to fulfill higher-latency requests from a cloud/data center for websites, applications, database servers, etc. Additional or consolidated instances of the edge aggregation nodes 540 and the aggregation points 542, 544, including those deployed on a single server framework, may also be present within the edge cloud 310 or other areas of the TSP infrastructure.

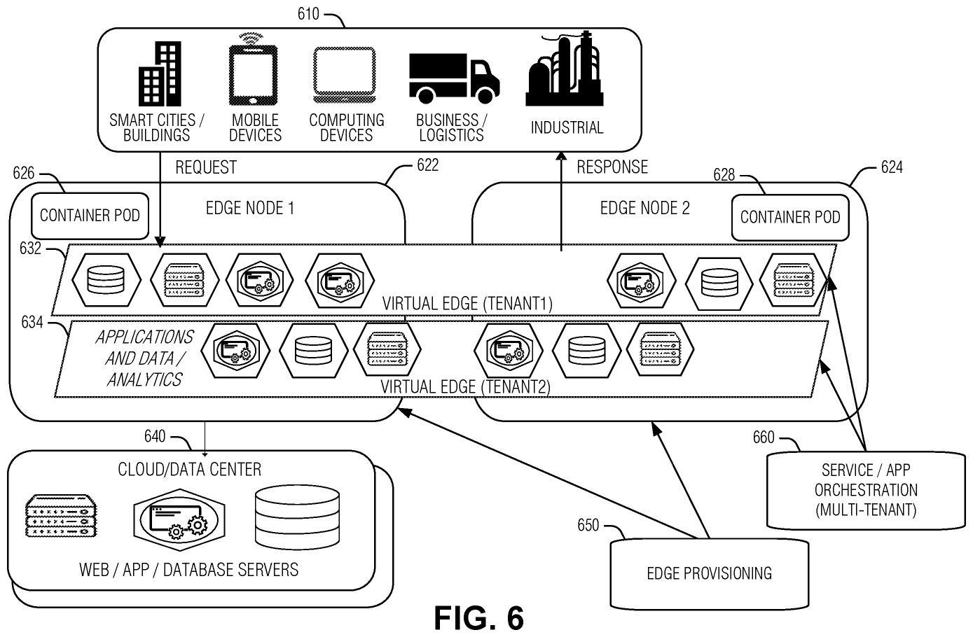

FIG. 6 illustrates deployment and orchestration for virtualized and container-based edge configurations across an edge computing system operated among multiple edge nodes and multiple tenants (e.g., users, providers) which use such edge nodes. Specifically, FIG. 6 depicts coordination of a first edge node 622 and a second edge node 624 in an edge computing system, to fulfill requests and responses for various client endpoints 610 (e.g., smart cities/building systems, mobile devices, computing devices, business/logistics systems, industrial systems, etc.), which access various virtual edge instances. Here, the virtual edge instances 632, 634 provide edge compute capabilities and processing in an edge cloud, with access to a cloud/data center 640 for higher-latency requests for websites, applications, database servers, etc. However, the edge cloud enables coordination of processing among multiple edge nodes for multiple tenants or entities.

In the example of FIG. 6, these virtual edge instances include: a first virtual edge 632, offered to a first tenant (Tenant 1), which offers a first combination of edge storage, computing, and services; and a second virtual edge 634, offering a second combination of edge storage, computing, and services. The virtual edge instances 632, 634 are distributed among the edge nodes 622, 624, and may include scenarios in which a request and response are fulfilled from the same or different edge nodes. The configuration of the edge nodes 622, 624 to operate in a distributed yet coordinated fashion occurs based on edge provisioning functions 650. The functionality of the edge nodes 622, 624 to provide coordinated operation for applications and services, among multiple tenants, occurs based on orchestration functions 660.

It should be understood that some of the devices in 610 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 622, 624 may operate as security feature enforcement points for local resources allocated to multiple tenants per node. Additionally, tenant runtime and application execution (e.g., in instances 632, 634) may serve as an enforcement point for a security feature that creates a virtual edge abstraction of resources spanning potentially multiple physical hosting platforms. Finally, the orchestration functions 660 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, Servlets, servers, or other computation abstraction that may be partitioned according to a DICE layering and fan-out structure to support a RoT context for each. Accordingly, the respective RoTs spanning devices 610, 622, and 640 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 6. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 622, 624 may implement the use of containers, such as with the use of a container “pod” 626, 628 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 632, 634 are partitioned according to the needs of each container.

With the use of container pods, a pod controller oversees the partitioning and allocation of containers and resources. The pod controller receives instructions from an orchestrator (e.g., orchestrator 660) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 660 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

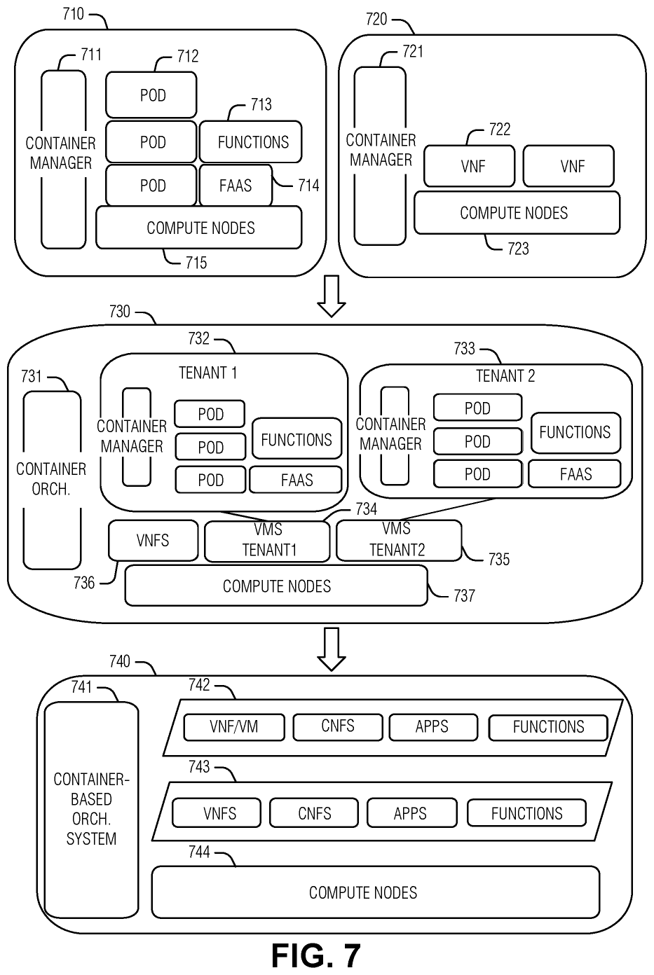

FIG. 7 illustrates additional compute arrangements deploying containers in an edge computing system. As a simplified example, system arrangements 710, 720 depict settings in which a pod controller (e.g., container managers 711, 721, and container orchestrator 731) is adapted to launch containerized pods, functions, and functions-as-a-service instances through execution via compute nodes (715 in arrangement 710), or to separately execute containerized virtualized network functions through execution via compute nodes (723 in arrangement 720). This arrangement is adapted for use of multiple tenants in system arrangement 730 (using compute nodes 737), where containerized pods (e.g., pods 712), functions (e.g., functions 713, VNFs 722, 736), and functions-as-a-service instances (e.g., FaaS instance 714) are launched within virtual machines (e.g., VMs 734, 735 for tenants 732, 733) specific to respective tenants (aside the execution of virtualized network functions). This arrangement is further adapted for use in system arrangement 740, which provides containers 742, 743, or execution of the various functions, applications, and functions on compute nodes 744, as coordinated by an container-based orchestration system 741.

The system arrangements of depicted in FIG. 7 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 7, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

In further examples, any of the compute nodes or devices discussed with reference to the present edge computing systems and environment may be fulfilled based on the components depicted in FIGS. 8A and 8B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 8A, an edge compute node 800 includes a compute engine (also referred to herein as “compute circuitry”) 802, an input/output (I/O) subsystem 808, data storage 810, a communication circuitry subsystem 812, and, optionally, one or more peripheral devices 814. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 800 may be embodied as any type of engine, device, or collection of devices capable of performing various compute functions. In some examples, the compute node 800 may be embodied as a single device such as an integrated circuit, an embedded system, a field-programmable gate array (FPGA), a system-on-a-chip (SOC), or other integrated system or device. In the illustrative example, the compute node 800 includes or is embodied as a processor 804 and a memory 806. The processor 804 may be embodied as any type of processor capable of performing the functions described herein (e.g., executing an application). For example, the processor 804 may be embodied as a multi-core processor(s), a microcontroller, a processing unit, a specialized or special purpose processing unit, or other processor or processing/controlling circuit.

In some examples, the processor 804 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 804 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 804 may work in coordination with each other to execute many types of operations and instructions within and on behalf of the compute node 800.

The memory 806 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 806 may be integrated into the processor 804. The memory 806 may store various software and data used during operation such as one or more applications, data operated on by the application(s), libraries, and drivers.

The compute circuitry 802 is communicatively coupled to other components of the compute node 800 via the I/O subsystem 808, which may be embodied as circuitry or components to facilitate input/output operations with the compute circuitry 802 (e.g., with the processor 804 or the main memory 806) and other components of the compute circuitry 802. For example, the I/O subsystem 808 may be embodied as, or otherwise include, memory controller hubs, input/output control hubs, integrated sensor hubs, firmware devices, communication links (e.g., point-to-point links, bus links, wires, cables, light guides, printed circuit board traces, etc.), or other components and subsystems to facilitate the input/output operations. In some examples, the I/O subsystem 808 may form a portion of a system-on-a-chip (SoC) and be incorporated, along with one or more of the processor 804, the memory 806, and other components of the compute circuitry 802, into the compute circuitry 802.

The one or more illustrative data storage devices 810 may be embodied as any type of devices configured for short-term or long-term storage of data such as, for example, memory devices and circuits, memory cards, hard disk drives, solid-state drives, or other data storage devices. Individual data storage devices 810 may include a system partition that stores data and firmware code for the data storage device 810. Individual data storage devices 810 may also include one or more operating system partitions that store data files and executables for operating systems depending on, for example, the type of compute node 800.

The communication circuitry 812 may be embodied as any communication circuit, device, or collection thereof, capable of enabling communications over a network between the compute circuitry 802 and another compute device (e.g., an edge gateway of an implementing edge computing system). The communication circuitry 812 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 812 includes a network interface controller (NIC) 820, which may also be referred to as a host fabric interface (HFI). The NIC 820 may be embodied as one or more add-in-boards, daughter cards, network interface cards, controller chips, chipsets, or other devices that may be used by the compute node 800 to connect with another compute device (e.g., an edge gateway node). In some examples, the NIC 820 may be embodied as part of a system-on-a-chip (SoC) that includes one or more processors, or included on a multichip package that also contains one or more processors. In some examples, the NIC 820 may include a local processor (not shown) or a local memory (not shown) that are both local to the NIC 820. In such examples, the local processor of the NIC 820 may be capable of performing one or more of the functions of the compute circuitry 802 described herein. Additionally, or alternatively, in such examples, the local memory of the NIC 820 may be integrated into one or more components of the client compute node at the board level, socket level, chip level, or other levels.

Additionally, in some examples, a respective compute node 800 may include one or more peripheral devices 814. Such peripheral devices 814 may include any type of peripheral device found in a compute device or server such as audio input devices, a display, other input/output devices, interface devices, or other peripheral devices, depending on the particular type of the compute node 800. In further examples, the compute node 800 may be embodied by a respective edge compute node (whether a client, gateway, or aggregation node) in an edge computing system or like forms of appliances, computers, subsystems, circuitry, or other components.

In a more detailed example, FIG. 8B illustrates a block diagram of an example of components that may be present in an edge computing node 850 for implementing the techniques (e.g., operations, processes, methods, and methodologies) described herein. This edge computing node 850 provides a closer view of the respective components of node 800 when implemented as or as part of a computing device (e.g., as a mobile device, a base station, server, gateway, etc.). The edge computing node 850 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 850, or as components otherwise incorporated within a chassis of a larger system.

The edge computing device 850 may include processing circuitry in the form of a processor 852, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 852 may be a part of a system on a chip (SoC) in which the processor 852 and other components are formed into a single integrated circuit, or a single package, such as the Edison™ or Galileo™ SoC boards from Intel Corporation, Santa Clara, Calif. As an example, the processor 852 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 852 and accompanying circuitry may be provided in a single socket form factor, multiple socket form factor, or a variety of other formats, including in limited hardware configurations or configurations that include fewer than all elements shown in FIG. 8B.

The processor 852 may communicate with a system memory 854 over an interconnect 856 (e.g., a bus). Any number of memory devices may be used to provide for a given amount of system memory. As examples, the memory 854 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 858 may also couple to the processor 852 via the interconnect 856. In an example, the storage 858 may be implemented via a solid-state disk drive (SSDD). Other devices that may be used for the storage 858 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 858 may be on-die memory or registers associated with the processor 852. However, in some examples, the storage 858 may be implemented using a micro hard disk drive (HDD). Further, any number of new technologies may be used for the storage 858 in addition to, or instead of, the technologies described, such resistance change memories, phase change memories, holographic memories, or chemical memories, among others.

The components may communicate over the interconnect 856. The interconnect 856 may include any number of technologies, including industry standard architecture (ISA), extended ISA (EISA), peripheral component interconnect (PCI), peripheral component interconnect extended (PCIx), PCI express (PCIe), or any number of other technologies. The interconnect 856 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 856 may couple the processor 852 to a transceiver 866, for communications with the connected edge devices 862. The transceiver 866 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 862. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 866 (or multiple transceivers) may communicate using multiple standards or radios for communications at a different range. For example, the edge computing node 850 may communicate with close devices, e.g., within about 10 meters, using a local transceiver based on Bluetooth Low Energy (BLE), or another low power radio, to save power. More distant connected edge devices 862, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 866 (e.g., a radio transceiver) may be included to communicate with devices or services in a cloud (e.g., an edge cloud 895) via local or wide area network protocols. The wireless network transceiver 866 may be a low-power wide-area (LPWA) transceiver that follows the IEEE 802.15.4, or IEEE 802.15.4g standards, among others. The edge computing node 850 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 866, as described herein. For example, the transceiver 866 may include a cellular transceiver that uses spread spectrum (SPA/SAS) communications for implementing high-speed communications. Further, any number of other protocols may be used, such as Wi-Fi® networks for medium speed communications and provision of network communications. The transceiver 866 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 868 may be included to provide a wired communication to nodes of the edge cloud 895 or to other devices, such as the connected edge devices 862 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 868 may be included to enable connecting to a second network, for example, a first NIC 868 providing communications to the cloud over Ethernet, and a second NIC 868 providing communications to other devices over another type of network.

Given the variety of types of applicable communications from the device to another component or network, applicable communications circuitry used by the device may include or be embodied by any one or more of components 864, 866, 868, or 870. Accordingly, in various examples, applicable means for communicating (e.g., receiving, transmitting, etc.) may be embodied by such communications circuitry.

The edge computing node 850 may include or be coupled to acceleration circuitry 864, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 856 may couple the processor 852 to a sensor hub or external interface 870 that is used to connect additional devices or subsystems. The devices may include sensors 872, such as accelerometers, level sensors, flow sensors, optical light sensors, camera sensors, temperature sensors, global navigation system (e.g., GPS) sensors, pressure sensors, barometric pressure sensors, and the like. The hub or interface 870 further may be used to connect the edge computing node 850 to actuators 874, such as power switches, valve actuators, an audible sound generator, a visual warning device, and the like.

In some optional examples, various input/output (I/O) devices may be present within or connected to, the edge computing node 850. For example, a display or other output device 884 may be included to show information, such as sensor readings or actuator position. An input device 886, such as a touch screen or keypad may be included to accept input. An output device 884 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 850. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 876 may power the edge computing node 850, although, in examples in which the edge computing node 850 is mounted in a fixed location, it may have a power supply coupled to an electrical grid, or the battery may be used as a backup or for temporary capabilities. The battery 876 may be a lithium ion battery, or a metal-air battery, such as a zinc-air battery, an aluminum-air battery, a lithium-air battery, and the like.

A battery monitor/charger 878 may be included in the edge computing node 850 to track the state of charge (SoCh) of the battery 876, if included. The battery monitor/charger 878 may be used to monitor other parameters of the battery 876 to provide failure predictions, such as the state of health (SoH) and the state of function (SoF) of the battery 876. The battery monitor/charger 878 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 878 may communicate the information on the battery 876 to the processor 852 over the interconnect 856. The battery monitor/charger 878 may also include an analog-to-digital (ADC) converter that enables the processor 852 to directly monitor the voltage of the battery 876 or the current flow from the battery 876. The battery parameters may be used to determine actions that the edge computing node 850 may perform, such as transmission frequency, mesh network operation, sensing frequency, and the like.

A power block 880, or other power supply coupled to a grid, may be coupled with the battery monitor/charger 878 to charge the battery 876. In some examples, the power block 880 may be replaced with a wireless power receiver to obtain the power wirelessly, for example, through a loop antenna in the edge computing node 850. A wireless battery charging circuit, such as an LTC4020 chip from Linear Technologies of Milpitas, Calif., among others, may be included in the battery monitor/charger 878. The specific charging circuits may be selected based on the size of the battery 876, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 858 may include instructions 882 in the form of software, firmware, or hardware commands to implement the techniques described herein. Although such instructions 882 are shown as code blocks included in the memory 854 and the storage 858, it may be understood that any of the code blocks may be replaced with hardwired circuits, for example, built into an application specific integrated circuit (ASIC).

In an example, the instructions 882 provided via the memory 854, the storage 858, or the processor 852 may be embodied as a non-transitory, machine-readable medium 860 including code to direct the processor 852 to perform electronic operations in the edge computing node 850. The processor 852 may access the non-transitory, machine-readable medium 860 over the interconnect 856. For instance, the non-transitory, machine-readable medium 860 may be embodied by devices described for the storage 858 or may include specific storage units such as optical disks, flash drives, or any number of other hardware devices. The non-transitory, machine-readable medium 860 may include instructions to direct the processor 852 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 882 on the processor 852 (separately, or in combination with the instructions 882 of the machine readable medium 860) may configure execution or operation of a trusted execution environment (TEE) 890. In an example, the TEE 890 operates as a protected area accessible to the processor 852 for secure execution of instructions and secure access to data. Various implementations of the TEE 890, and an accompanying secure area in the processor 852 or the memory 854 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 850 through the TEE 890 and the processor 852.

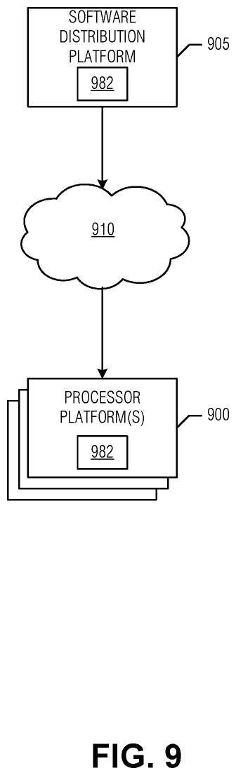

FIG. 9 illustrates an example software distribution platform 905 to distribute software, such as the example computer readable instructions 982 of FIG. 9, to one or more devices, such as example processor platform(s) 900 or connected edge devices. The example software distribution platform 905 may be implemented by any computer server, data facility, cloud service, etc., capable of storing and transmitting software to other computing devices (e.g., third parties, or connected edge devices). Example connected edge devices may be customers, clients, managing devices (e.g., servers), third parties (e.g., customers of an entity owning or operating the software distribution platform 905). Example connected edge devices may operate in commercial or home automation environments. In some examples, a third party is a developer, a seller, or a licensor of software such as the example computer readable instructions 982 of FIG. 9. The third parties may be consumers, users, retailers, OEMs, etc. that purchase or license the software for use or re-sale or sub-licensing. In some examples, distributed software causes display of one or more user interfaces (UIs) or graphical user interfaces (GUIs) to identify the one or more devices (e.g., connected edge devices) geographically or logically separated from each other (e.g., physically separated IoT devices chartered with the responsibility of water distribution control (e.g., pumps), electricity distribution control (e.g., relays), etc.).

In the illustrated example of FIG. 9, the software distribution platform 905 includes one or more servers and one or more storage devices. The storage devices store the computer readable instructions 982, which may correspond to the example computer readable instructions illustrated in the figures and described herein. The one or more servers of the example software distribution platform 905 are in communication with a network 910, which may correspond to any one or more of the Internet or any of the example networks described herein. In some examples, the one or more servers are responsive to requests to transmit the software to a requesting party as part of a commercial transaction. Payment for the delivery, sale or license of the software may be handled by the one or more servers of the software distribution platform or via a third-party payment entity. The servers enable purchasers or licensors to download the computer readable instructions 982 from the software distribution platform 905. For example, the software, which may correspond to the example computer readable instructions described herein, may be downloaded to the example processor platform(s) 900 (e.g., example connected edge devices), which are to execute the computer readable instructions 982 to implement the technique. In some examples, one or more servers of the software distribution platform 905 are communicatively connected to one or more security domains or security devices through which requests and transmissions of the example computer readable instructions 982 must pass. In some examples, one or more servers of the software distribution platform 905 periodically offer, transmit, or force updates to the software (e.g., the example computer readable instructions 982 of FIG. 9) to ensure improvements, patches, updates, etc. are distributed and applied to the software at the end user devices.

In the illustrated example of FIG. 9, the computer readable instructions 982 are stored on storage devices of the software distribution platform 905 in a particular format. A format of computer readable instructions includes, but is not limited to a particular code language (e.g., Java, JavaScript, Python, C, C #, SQL, HTML, etc.), or a particular code state (e.g., uncompiled code (e.g., ASCII), interpreted code, linked code, executable code (e.g., a binary), etc.). In some examples, the computer readable instructions 982 stored in the software distribution platform 905 are in a first format when transmitted to the example processor platform(s) 900. In some examples, the first format is an executable binary in which particular types of the processor platform(s) 900 can execute. However, in some examples, the first format is uncompiled code that requires one or more preparation tasks to transform the first format to a second format to enable execution on the example processor platform(s) 900. For instance, the receiving processor platform(s) 900 may need to compile the computer readable instructions 982 in the first format to generate executable code in a second format that is capable of being executed on the processor platform(s) 900. In still other examples, the first format is interpreted code that, upon reaching the processor platform(s) 900, is interpreted by an interpreter to facilitate execution of instructions.

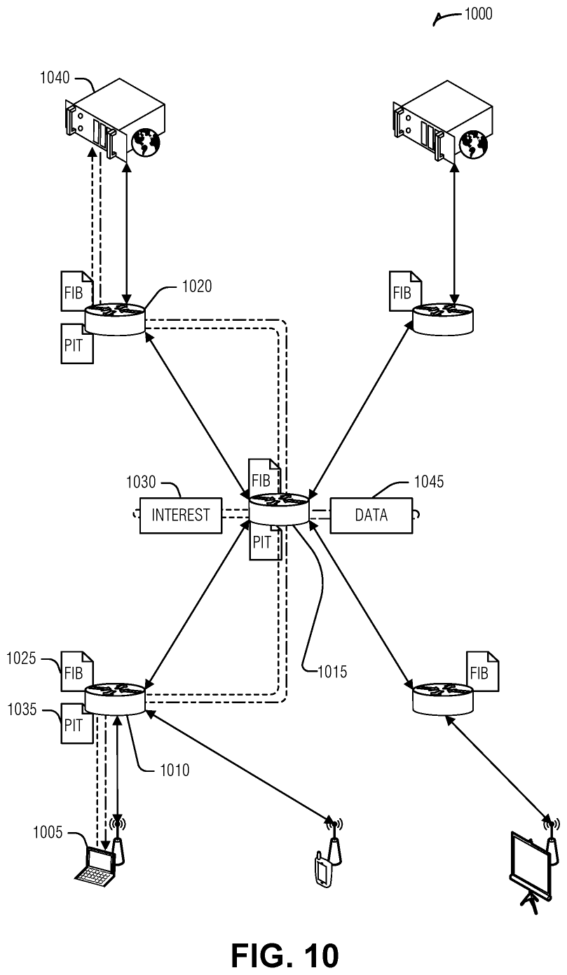

FIG. 10 illustrates an example information centric network (ICN), according to an embodiment. ICNs operate differently than traditional host-based (e.g., address-based) communication networks. ICN is an umbrella term for a networking paradigm in which information and/or functions themselves are named and requested from the network instead of hosts (e.g., machines that provide information). In a host-based networking paradigm, such as used in the Internet protocol (IP), a device locates a host and requests content from the host. The network understands how to route (e.g., direct) packets based on the address specified in the packet. In contrast, ICN does not include a request for a particular machine and does not use addresses. Instead, to get content, a device 1005 (e.g., subscriber) requests named content from the network itself. The content request may be called an interest and transmitted via an interest packet 1030. As the interest packet traverses network devices (e.g., network elements, routers, switches, hubs, etc.)—such as network elements 1010, 1015, and 1020—a record of the interest is kept, for example, in a pending interest table (PIT) at each network element. Thus, network element 1010 maintains an entry in its PIT 1035 for the interest packet 1030, network element 1015 maintains the entry in its PIT, and network element 1020 maintains the entry in its PIT.

When a device, such as publisher 1040, that has content matching the name in the interest packet 1030 is encountered, that device 1040 may send a data packet 1045 in response to the interest packet 1030. Typically, the data packet 1045 is tracked back through the network to the source (e.g., device 1005) by following the traces of the interest packet 1030 left in the network element PITs. Thus, the PIT 1035 at each network element establishes a trail back to the subscriber 1005 for the data packet 1045 to follow.

Matching the named data in an ICN may follow several strategies. Generally, the data is named hierarchically, such as with a universal resource identifier (URI). For example, a video may be named www.somedomain.com or videos or v8675309. Here, the hierarchy may be seen as the publisher, “www.somedomain.com,” a sub-category, “videos,” and the canonical identification “v8675309.” As an interest 1030 traverses the ICN, ICN network elements will generally attempt to match the name to a greatest degree. Thus, if an ICN element has a cached item or route for both “www.somedomain.com or videos” and “www.somedomain.com or videos or v8675309,” the ICN element will match the later for an interest packet 1030 specifying “www.somedomain.com or videos or v8675309.” In an example, an expression may be used in matching by the ICN device. For example, the interest packet may specify “www.somedomain.com or videos or v8675*” where ‘*’ is a wildcard. Thus, any cached item or route that includes the data other than the wildcard will be matched.

Item matching involves matching the interest 1030 to data cached in the ICN element. Thus, for example, if the data 1045 named in the interest 1030 is cached in network element 1015, then the network element 1015 will return the data 1045 to the subscriber 1005 via the network element 1010. However, if the data 1045 is not cached at network element 1015, the network element 1015 routes the interest 1030 on (e.g., to network element 1020). To facilitate routing, the network elements may use a forwarding information base 1025 (FIB) to match named data to an interface (e.g., physical port) for the route. Thus, the FIB 1025 operates much like a routing table on a traditional network device.

In an example, additional metadata may be attached to the interest packet 1030, the cached data, or the route (e.g., in the FIB 1025), to provide an additional level of matching. For example, the data name may be specified as “www.somedomain.com or videos or v8675309,” but also include a version number—or timestamp, time range, endorsement, etc. In this example, the interest packet 1030 may specify the desired name, the version number, or the version range. The matching may then locate routes or cached data matching the name and perform the additional comparison of metadata or the like to arrive at an ultimate decision as to whether data or a route matches the interest packet 1030 for respectively responding to the interest packet 1030 with the data packet 1045 or forwarding the interest packet 1030.

ICN has advantages over host-based networking because the data segments are individually named. This enables aggressive caching throughout the network as a network element may provide a data packet 1030 in response to an interest 1030 as easily as an original author 1040. Accordingly, it is less likely that the same segment of the network will transmit duplicates of the same data requested by different devices.

Fine grained encryption is another feature of many ICN networks. A typical data packet 1045 includes a name for the data that matches the name in the interest packet 1030. Further, the data packet 1045 includes the requested data and may include additional information to filter similarly named data (e.g., by creation time, expiration time, version, etc.). To address malicious entities providing false information under the same name, the data packet 1045 may also encrypt its contents with a publisher key or provide a cryptographic hash of the data and the name. Thus, knowing the key (e.g., from a certificate of an expected publisher 1040) enables the recipient to ascertain whether the data is from that publisher 1040. This technique also facilitates the aggressive caching of the data packets 1045 throughout the network because each data packet 1045 is self-contained and secure. In contrast, many host-based networks rely on encrypting a connection between two hosts to secure communications. This may increase latencies while connections are being established and prevents data caching by hiding the data from the network elements.

Example ICN networks include content centric networking (CCN), as specified in the Internet Engineering Task Force (IETF) draft specifications for CCNx 0.x and CCN 1.x, and named data networking (NDN), as specified in the NDN technical report DND-0001.

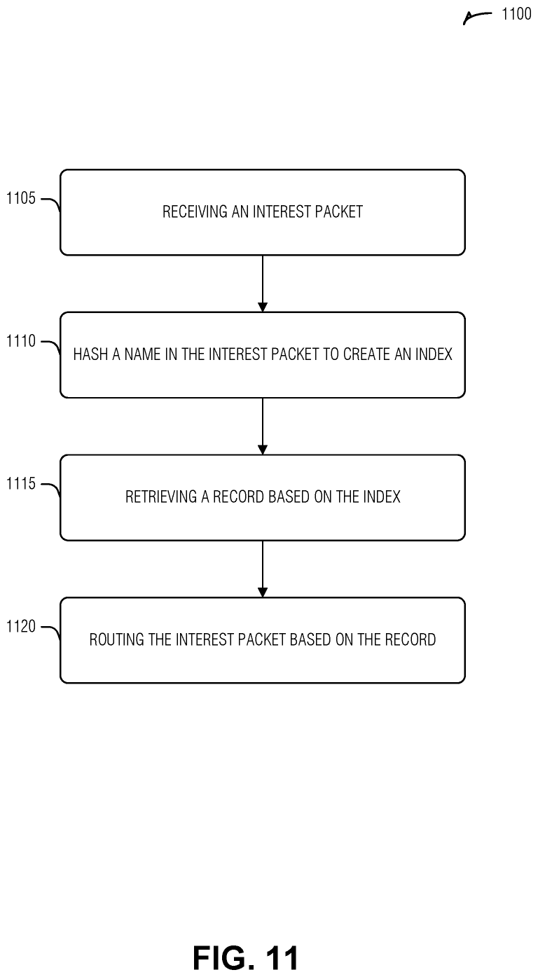

FIG. 11 illustrates a flow diagram of an example of a method 1100 for ICN routing, according to an embodiment. The operations of the method 1100 are performed by computational hardware, such as that described above (e.g., NFN node A 110 illustrated in FIG. 1) or below (e.g., processing circuitry).

At operation 1105, an interest packet including a name for content is received (e.g., at an ICN node). In an example, the content is data. In an example, the content is a result of a function. In an example, the ICN node executes the function to produce the result in response to the interest packet.

At operation 1110, the name of the interest packet is hashed to create an index.

At operation 1115, a bit that corresponds to the index is retrieved from an array of bits. In an example, the bit indicates that the content may be present on the ICN node. In an example, the hash and the bit array are a bloom filter. In an example, the bloom filter is a cryptographic bloom filter. In an example, a version of the content on the ICN node may be expunged (e.g., removed, deleted, etc.) in response to the bit indicating that the content is not on the ICN node.

In an example, the bit array is one of multiple bit arrays used by the ICN node for interest packet routing. Here, the multiple bit arrays are respectively assigned to tenants of the ICN node. In an example, the multiple bit arrays each have a set of properties. In an example, the properties include load balancing, permission, or temporality that are assigned to a tenant from the tenants.

At operation 1120, the interest packet is routed based on the bit. In an example, where the bit from operation 1115 indicates that the content may be present on the ICN node, routing the interest packet based on the bit includes finding the content in a repository of the ICN node and transmitting a data packet with the content in accordance with a pending interest table (PIT) entry for the interest packet.

In an example, routing the interest packet based on the bit includes searching for the content in a repository of the ICN node to determine that the content is not available at the ICN node, retrieving a second bit from a second array of bits corresponding to forward routes, and routing the interest packet based on the second bit. In an example, the second bit indicates that the content is not present on a forward route. Here, routing the interest packet based on the second bit includes dropping the interest packet.

In an example, the second bit indicates that the content may be present on one or more forward routes. Here, routing the interest packet includes transmitting the interest packet along the one or more forward routes. In an example, a data structure is searched using the index to determine the one or more forward routes based on the index and the name. In an example, the data structure includes a set of properties for the content. In an example, properties include one or more of a content name, hop count, or hash index. In an example, the searching produces multiple forward routes. Here, routing the interest packet includes ordering the multiple forward routes based on hop count and selecting the highest ordered route. Then, the interest packet is transmitted using the highest ordered route.

In an example, a third bit array from is received from an ICN node on a forward route. Then, the third bit array may be bitwise-ORed with the second bit array to produce a result. The second bit array may be set to (e.g., replaced by) this result. In an example, the third bit array was received in a data packet from the ICN node on the forward route.

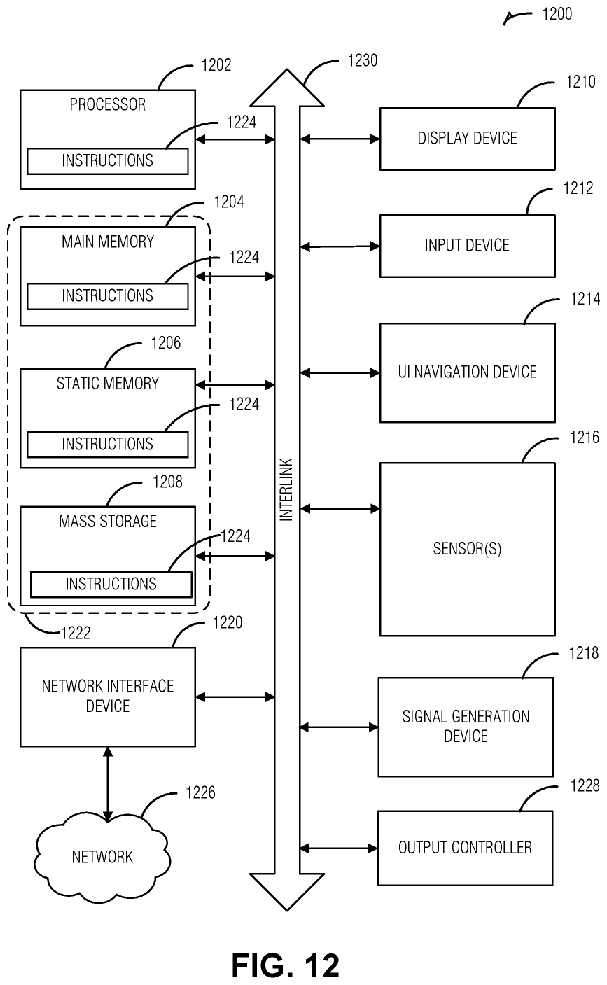

FIG. 12 illustrates a block diagram of an example machine 1200 upon which any one or more of the techniques (e.g., methodologies) discussed herein may perform. Examples, as described herein, may include, or may operate by, logic or a number of components, or mechanisms in the machine 1200. Circuitry (e.g., processing circuitry) is a collection of circuits implemented in tangible entities of the machine 1200 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1200 follow.

In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1200 may include a hardware processor 1202 (e.g., a central processing unit (CPU), a graphics processing unit (GPU), a hardware processor core, or any combination thereof), a main memory 1204, a static memory (e.g., memory or storage for firmware, microcode, a basic-input-output (BIOS), unified extensible firmware interface (UEFI), etc.) 1206, and mass storage 1208 (e.g., hard drives, tape drives, flash storage, or other block devices) some or all of which may communicate with each other via an interlink (e.g., bus) 1230. The machine 1200 may further include a display unit 1210, an alphanumeric input device 1212 (e.g., a keyboard), and a user interface (UI) navigation device 1214 (e.g., a mouse). In an example, the display unit 1210, input device 1212 and UI navigation device 1214 may be a touch screen display. The machine 1200 may additionally include a storage device (e.g., drive unit) 1208, a signal generation device 1218 (e.g., a speaker), a network interface device 1220, and one or more sensors 1216, such as a global positioning system (GPS) sensor, compass, accelerometer, or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1202, the main memory 1204, the static memory 1206, or the mass storage 1208 may be, or include, a machine readable medium 1222 on which is stored one or more sets of data structures or instructions 1224 (e.g., software) embodying or utilized by any one or more of the techniques or functions described herein. The instructions 1224 may also reside, completely or at least partially, within any of registers of the processor 1202, the main memory 1204, the static memory 1206, or the mass storage 1208 during execution thereof by the machine 1200. In an example, one or any combination of the hardware processor 1202, the main memory 1204, the static memory 1206, or the mass storage 1208 may constitute the machine readable media 1222. While the machine readable medium 1222 is illustrated as a single medium, the term “machine readable medium” may include a single medium or multiple media (e.g., a centralized or distributed database, or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 1222 may be representative of the instructions 1224, such as instructions 1224 themselves or a format from which the instructions 1224 may be derived. This format from which the instructions 1224 may be derived may include source code, encoded instructions (e.g., in compressed or encrypted form), packaged instructions (e.g., split into multiple packages), or the like. The information representative of the instructions 1224 in the machine readable medium 1222 may be processed by processing circuitry into the instructions to implement any of the operations discussed herein. For example, deriving the instructions 1224 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1224.

In an example, the derivation of the instructions 1224 may include assembly, compilation, or interpretation of the information (e.g., by the processing circuitry) to create the instructions 1224 from some intermediate or preprocessed format provided by the machine readable medium 1222. The information, when provided in multiple parts, may be combined, unpacked, and modified to create the instructions 1224. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1224 may be further transmitted or received over a communications network 1226 using a transmission medium via the network interface device 1220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, peer-to-peer (P2P) networks, among others. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1200, and includes digital or analog communications signals or other intangible medium to facilitate communication of such software. A transmission medium is a machine readable medium.

### Additional Notes & Examples

Example 1 is a device for information centric network (ICN) routing, the device comprising: a memory including instructions; and processing circuitry that, when in operation, is configured by the instructions to: receive, at an ICN node, an interest packet including a name for content; hash, by processing circuitry of the ICN node, the name to create an index; retrieve, by the processing circuitry, a bit that corresponds to the index from an array of bits; and route, by the processing circuitry, the interest packet based on the bit.

In Example 2, the subject matter of Example 1, wherein the content is a result of a function.

In Example 3, the subject matter of Example 2, wherein the ICN node executes the function to produce the result in response to the interest packet.

In Example 4, the subject matter of any of Examples 1-3, wherein the content is data.

In Example 5, the subject matter of any of Examples 1-4, wherein the bit indicates that the content may be present on the ICN node.

In Example 6, the subject matter of Example 5, wherein, to route the interest packet based on the bit, the processing circuitry: finds the content in a repository of the ICN node; and transmits a data packet with the content in accordance with a pending interest table (PIT) entry for the interest packet.

In Example 7, the subject matter of any of Examples 5-6, wherein, to route the interest packet based on the bit, the processing circuitry: searches for the content in a repository of the ICN node to determine that the content is not available at the ICN node; retrieves a second bit from a second array of bits corresponding to forward routes; and routes the interest packet based on the second bit.

In Example 8, the subject matter of Example 7, wherein the second bit indicates that the content is not present on a forward route, and wherein, to route the interest packet based on the second bit, the processing circuitry drops the interest packet.

In Example 9, the subject matter of any of Examples 7-8, wherein the second bit indicates that the content may be present on one or more forward routes, and wherein, to route the interest packet, the processing circuitry transmits the interest packet along the one or more forward routes.

In Example 10, the subject matter of Example 9, wherein the instructions configure the processing circuitry to search a data structure using the index to determine the one or more forward routes based on the index and the name.

In Example 11, the subject matter of Example 10, wherein the search of the data structure produces multiple forward routes, and wherein, to route the interest packet, the processing circuitry: orders the multiple forward routes based on hop count; selects a highest ordered route; and transmits the interest packet along the highest ordered route.

In Example 12, the subject matter of any of Examples 10-11, wherein the data structure includes a set of properties for the content, the properties including: a content name; a hop count; or a hash index.

In Example 13, the subject matter of any of Examples 7-12, wherein the instructions configure the processing circuitry to: receive a third bit array from an ICN node on a forward route; bitwise-OR the third bit array with the second bit array to produce a result; and set the second bit array to the result.

In Example 14, the subject matter of Example 13, wherein the third bit array was received in a data packet from the ICN node on the forward route.

In Example 15, the subject matter of any of Examples 1-14, wherein the hash and the bit array are a bloom filter.

In Example 16, the subject matter of Example 15, wherein the bloom filter is a cryptographic bloom filter.

In Example 17, the subject matter of Example 16, wherein the instructions configure the processing circuitry to expunge a version of the content on the ICN node in response to the bit indicating that the content is not on the ICN node.

In Example 18, the subject matter of any of Examples 1-17, wherein the bit array is one of multiple bit arrays used by the ICN node for interest packet routing, the multiple bit arrays are respectively assigned to tenants of the ICN node.

In Example 19, the subject matter of Example 18, wherein the multiple bit arrays each have a set of properties for load balancing, permission, or temporality that are assigned to a tenant from the tenants.

Example 20 is a method for information centric network (ICN) routing, the method comprising: receiving, at an ICN node, an interest packet including a name for content; hashing, by processing circuitry of the ICN node, the name to create an index; retrieving, by the processing circuitry, a bit that corresponds to the index from an array of bits; and routing, by the processing circuitry, the interest packet based on the bit.

In Example 21, the subject matter of Example 20, wherein the content is a result of a function.

In Example 22, the subject matter of Example 21, wherein the ICN node executes the function to produce the result in response to the interest packet.

In Example 23, the subject matter of any of Examples 20-22, wherein the content is data.

In Example 24, the subject matter of any of Examples 20-23, wherein the bit indicates that the content may be present on the ICN node.

In Example 25, the subject matter of Example 24, wherein routing the interest packet based on the bit includes: finding the content in a repository of the ICN node; and transmitting a data packet with the content in accordance with a pending interest table (PIT) entry for the interest packet.

In Example 26, the subject matter of any of Examples 24-25, wherein routing the interest packet based on the bit includes: searching for the content in a repository of the ICN node to determine that the content is not available at the ICN node; retrieving a second bit from a second array of bits corresponding to forward routes; and routing the interest packet based on the second bit.

In Example 27, the subject matter of Example 26, wherein the second bit indicates that the content is not present on a forward route, and wherein routing the interest packet based on the second bit includes dropping the interest packet.

In Example 28, the subject matter of any of Examples 26-27, wherein the second bit indicates that the content may be present on one or more forward routes, and wherein routing the interest packet includes transmitting the interest packet along the one or more forward routes.

In Example 29, the subject matter of Example 28, comprising searching a data structure using the index to determine the one or more forward routes based on the index and the name.

In Example 30, the subject matter of Example 29, wherein searching the data structure produces multiple forward routes, and wherein routing the interest packet includes: ordering the multiple forward routes based on hop count; selecting a highest ordered route; and transmitting the interest packet along the highest ordered route.

In Example 31, the subject matter of any of Examples 29-30, wherein the data structure includes a set of properties for the content, the properties including: a content name; a hop count; or a hash index.

In Example 32, the subject matter of any of Examples 26-31, comprising: receiving a third bit array from an ICN node on a forward route; bitwise-ORing the third bit array with the second bit array to produce a result; and setting the second bit array to the result.

In Example 33, the subject matter of Example 32, wherein the third bit array was received in a data packet from the ICN node on the forward route.

In Example 34, the subject matter of any of Examples 20-33, wherein the hash and the bit array are a bloom filter.

In Example 35, the subject matter of Example 34, wherein the bloom filter is a cryptographic bloom filter.

In Example 36, the subject matter of Example 35, comprising expunging a version of the content on the ICN node in response to the bit indicating that the content is not on the ICN node.

In Example 37, the subject matter of any of Examples 20-36, wherein the bit array is one of multiple bit arrays used by the ICN node for interest packet routing, the multiple bit arrays are respectively assigned to tenants of the ICN node.

In Example 38, the subject matter of Example 37, wherein the multiple bit arrays each have a set of properties for load balancing, permission, or temporality that are assigned to a tenant from the tenants.

Example 39 is at least one machine readable medium including instructions for information centric network (ICN) routing, the instructions, when executed by processing circuitry, cause the processing circuitry to perform operations comprising: receiving, at an ICN node, an interest packet including a name for content; hashing, by processing circuitry of the ICN node, the name to create an index; retrieving, by the processing circuitry, a bit that corresponds to the index from an array of bits; and routing, by the processing circuitry, the interest packet based on the bit.

In Example 40, the subject matter of Example 39, wherein the content is a result of a function.

In Example 41, the subject matter of Example 40, wherein the ICN node executes the function to produce the result in response to the interest packet.

In Example 42, the subject matter of any of Examples 39-41, wherein the content is data.

In Example 43, the subject matter of any of Examples 39-42, wherein the bit indicates that the content may be present on the ICN node.

In Example 44, the subject matter of Example 43, wherein routing the interest packet based on the bit includes: finding the content in a repository of the ICN node; and transmitting a data packet with the content in accordance with a pending interest table (PIT) entry for the interest packet.

In Example 45, the subject matter of any of Examples 43-44, wherein routing the interest packet based on the bit includes: searching for the content in a repository of the ICN node to determine that the content is not available at the ICN node; retrieving a second bit from a second array of bits corresponding to forward routes; and routing the interest packet based on the second bit.

In Example 46, the subject matter of Example 45, wherein the second bit indicates that the content is not present on a forward route, and wherein routing the interest packet based on the second bit includes dropping the interest packet.

In Example 47, the subject matter of any of Examples 45-46, wherein the second bit indicates that the content may be present on one or more forward routes, and wherein routing the interest packet includes transmitting the interest packet along the one or more forward routes.

In Example 48, the subject matter of Example 47, wherein the operations comprise searching a data structure using the index to determine the one or more forward routes based on the index and the name.

In Example 49, the subject matter of Example 48, wherein searching the data structure produces multiple forward routes, and wherein routing the interest packet includes: ordering the multiple forward routes based on hop count; selecting a highest ordered route; and transmitting the interest packet along the highest ordered route.

In Example 50, the subject matter of any of Examples 48-49, wherein the data structure includes a set of properties for the content, the properties including: a content name; a hop count; or a hash index.

In Example 51, the subject matter of any of Examples 45-50, wherein the operations comprise: receiving a third bit array from an ICN node on a forward route; bitwise-ORing the third bit array with the second bit array to produce a result; and setting the second bit array to the result.

In Example 52, the subject matter of Example 51, wherein the third bit array was received in a data packet from the ICN node on the forward route.

In Example 53, the subject matter of any of Examples 39-52, wherein the hash and the bit array are a bloom filter.

In Example 54, the subject matter of Example 53, wherein the bloom filter is a cryptographic bloom filter.

In Example 55, the subject matter of Example 54, wherein the operations comprise expunging a version of the content on the ICN node in response to the bit indicating that the content is not on the ICN node.

In Example 56, the subject matter of any of Examples 39-55, wherein the bit array is one of multiple bit arrays used by the ICN node for interest packet routing, the multiple bit arrays are respectively assigned to tenants of the ICN node.

In Example 57, the subject matter of Example 56, wherein the multiple bit arrays each have a set of properties for load balancing, permission, or temporality that are assigned to a tenant from the tenants.

Example 58 is a system for information centric network (ICN) routing, the system comprising: means for receiving, at an ICN node, an interest packet including a name for content; means for hashing, by processing circuitry of the ICN node, the name to create an index; means for retrieving, by the processing circuitry, a bit that corresponds to the index from an array of bits; and means for routing, by the processing circuitry, the interest packet based on the bit.

In Example 59, the subject matter of Example 58, wherein the content is a result of a function.

In Example 60, the subject matter of Example 59, wherein the ICN node executes the function to produce the result in response to the interest packet.

In Example 61, the subject matter of any of Examples 58-60, wherein the content is data.

In Example 62, the subject matter of any of Examples 58-61, wherein the bit indicates that the content may be present on the ICN node.

In Example 63, the subject matter of Example 62, wherein the means for routing the interest packet based on the bit include: means for finding the content in a repository of the ICN node; and means for transmitting a data packet with the content in accordance with a pending interest table (PIT) entry for the interest packet.

In Example 64, the subject matter of any of Examples 62-63, wherein the means for routing the interest packet based on the bit include: means for searching for the content in a repository of the ICN node to determine that the content is not available at the ICN node; means for retrieving a second bit from a second array of bits corresponding to forward routes; and means for routing the interest packet based on the second bit.

In Example 65, the subject matter of Example 64, wherein the second bit indicates that the content is not present on a forward route, and wherein the means for routing the interest packet based on the second bit include means for dropping the interest packet.

In Example 66, the subject matter of any of Examples 64-65, wherein the second bit indicates that the content may be present on one or more forward routes, and wherein the means for routing the interest packet include means for transmitting the interest packet along the one or more forward routes.

In Example 67, the subject matter of Example 66, comprising means for searching a data structure using the index to determine the one or more forward routes based on the index and the name.

In Example 68, the subject matter of Example 67, wherein the means for searching the data structure produces multiple forward routes, and wherein the means for routing the interest packet include: means for ordering the multiple forward routes based on hop count; means for selecting a highest ordered route; and means for transmitting the interest packet along the highest ordered route.

In Example 69, the subject matter of any of Examples 67-68, wherein the data structure includes a set of properties for the content, the properties including: a content name; a hop count; or a hash index.

In Example 70, the subject matter of any of Examples 64-69, comprising: means for receiving a third bit array from an ICN node on a forward route; means for bitwise-ORing the third bit array with the second bit array to produce a result; and means for setting the second bit array to the result.

In Example 71, the subject matter of Example 70, wherein the third bit array was received in a data packet from the ICN node on the forward route.

In Example 72, the subject matter of any of Examples 58-71, wherein the hash and the bit array are a bloom filter.

In Example 73, the subject matter of Example 72, wherein the bloom filter is a cryptographic bloom filter.

In Example 74, the subject matter of Example 73, comprising means for expunging a version of the content on the ICN node in response to the bit indicating that the content is not on the ICN node.

In Example 75, the subject matter of any of Examples 58-74, wherein the bit array is one of multiple bit arrays used by the ICN node for interest packet routing, the multiple bit arrays are respectively assigned to tenants of the ICN node.

In Example 76, the subject matter of Example 75, wherein the multiple bit arrays each have a set of properties for load balancing, permission, or temporality that are assigned to a tenant from the tenants.

PNUMExample 77 is at least one machine-readable medium including instructions that, when executed by processing circuitry, cause the processing circuitry to perform operations to implement of any of Examples 1-76.
PNUMExample 78 is an apparatus comprising means to implement of any of Examples 1-76.
PNUMExample 79 is a system to implement of any of Examples 1-76.
PNUMExample 80 is a method to implement of any of Examples 1-76.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device comprising:
a memory including instructions; and
processing circuitry that, when in operation, is configured by the instructions to:
receive, at an information centric network (ICN) node, an interest packet including a name for content;
hash, by processing circuitry of the ICN node, the name to create an index;
retrieve, by the processing circuitry, a bit that corresponds to the index from an array of bits; and
route, by the processing circuitry, the interest packet based on the bit.

2. The device of claim 1, wherein the bit indicates that the content may be present on the ICN node.

3. The device of claim 2, wherein, to route the interest packet based on the bit, the processing circuitry:
finds the content in a repository of the ICN node; and
transmits a data packet with the content in accordance with a pending interest table (PIT) entry for the interest packet.

4. The device of claim 2, wherein, to route the interest packet based on the bit, the processing circuitry:
searches for the content in a repository of the ICN node to determine that the content is not available at the ICN node;
retrieves a second bit from a second array of bits corresponding to forward routes; and
routes the interest packet based on the second bit.

5. The device of claim 4, wherein the second bit indicates that the content is not present on a forward route, and wherein, to route the interest packet based on the second bit, the processing circuitry drops the interest packet.

6. The device of claim 4, wherein the second bit indicates that the content may be present on one or more forward routes, and wherein, to route the interest packet, the processing circuitry transmits the interest packet along the one or more forward routes.

7. The device of claim 6, wherein the instructions configure the processing circuitry to search a data structure using the index to determine the one or more forward routes based on the index and the name.

8. The device of claim 7, wherein the search of the data structure produces multiple forward routes, and wherein, to route the interest packet, the processing circuitry:
orders the multiple forward routes based on hop count;
selects a highest ordered route; and
transmits the interest packet along the highest ordered route.

9. The device of claim 7, wherein the data structure includes a set of properties for the content, the properties including:
a content name;
a hop count; or
a hash index.

10. The device of claim 4, wherein the instructions configure the processing circuitry to:
receive a third bit array from an ICN node on a forward route;
bitwise-OR the third bit array with the second bit array to produce a result; and
set the second bit array to the result.

11. The device of claim 10, wherein the third bit array was received in a data packet from the ICN node on the forward route.

12. The device of claim 1, wherein the bit array is one of multiple bit arrays used by the ICN node for interest packet routing, the multiple bit arrays are respectively assigned to tenants of the ICN node.

13. At least one non-transitory machine readable medium including instructions that, when executed by processing circuitry, cause the processing circuitry to perform operations comprising:
receiving, at an information centric network (ICN) node, an interest packet including a name for content;
hashing, by processing circuitry of the ICN node, the name to create an index;
retrieving, by the processing circuitry, a bit that corresponds to the index from an array of bits; and
routing, by the processing circuitry, the interest packet based on the bit.

14. The at least one machine readable medium of claim 13, wherein the bit indicates that the content may be present on the ICN node.

15. The at least one machine readable medium of claim 14, wherein routing the interest packet based on the bit includes:
finding the content in a repository of the ICN node; and
transmitting a data packet with the content in accordance with a pending interest table (PIT) entry for the interest packet.

16. The at least one machine readable medium of claim 14, wherein routing the interest packet based on the bit includes:
searching for the content in a repository of the ICN node to determine that the content is not available at the ICN node;
retrieving a second bit from a second array of bits corresponding to forward routes; and
routing the interest packet based on the second bit.

17. The at least one machine readable medium of claim 16, wherein the second bit indicates that the content is not present on a forward route, and wherein routing the interest packet based on the second bit includes dropping the interest packet.

18. The at least one machine readable medium of claim 16, wherein the second bit indicates that the content may be present on one or more forward routes, and wherein routing the interest packet includes transmitting the interest packet along the one or more forward routes.

19. The at least one machine readable medium of claim 18, wherein the operations comprise searching a data structure using the index to determine the one or more forward routes based on the index and the name.

20. The at least one machine readable medium of claim 19, wherein searching the data structure produces multiple forward routes, and wherein routing the interest packet includes:
ordering the multiple forward routes based on hop count;
selecting a highest ordered route; and
transmitting the interest packet along the highest ordered route.

21. The at least one machine readable medium of claim 19, wherein the data structure includes a set of properties for the content, the properties including:
a content name;
a hop count; or
a hash index.

22. The at least one machine readable medium of claim 16, wherein the operations comprise:
receiving a third bit array from an ICN node on a forward route;
bitwise-ORing the third bit array with the second bit array to produce a result; and
setting the second bit array to the result.

23. The at least one machine readable medium of claim 22, wherein the third bit array was received in a data packet from the ICN node on the forward route.

24. The at least one machine readable medium of claim 13, wherein the bit array is one of multiple bit arrays used by the ICN node for interest packet routing, the multiple bit arrays are respectively assigned to tenants of the ICN node.
